(19) United States
(12) Patent Application Publication
(10) Pub. No.: US 2008/0035403 A1
(43) Pub. Date: Feb. 14, 2008

(54) Externally accessible torque overload components for an off-road motorcycle

(76) Inventor: Mark H. Hamilton, Northport, FL (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/503,587

(22) Filed: Aug. 14, 2006

(51) Int. Cl. B62D 61/02

(52) U.S. Cl. 180/224

(57) ABSTRACT

A dual wheel drive motorcycle includes a transmission that receives power and torque produced by the engine and, through multiple gears, provides power and torque to a rear wheel drive line and a front wheel drive line. The motorcycle is provided with an expendable and replaceable, torque overload component for both the rear wheel drive mechanism and the front wheel drive mechanism. The torque overload component is preferably a shear pin that is externally exposed and easily replaceable in the field. The transmission and front and rear drive lines are designed using keys, pins and adhesive to have sufficient torque capacity so that connections between these components can withstand greater torque loads than the torque overload components, thus protecting the internal components from failure due to shock loads during off-road or sporting uses. A safety factor of at least 1.5 is desirable in order to isolate failures within the externally accessible torque overload components.

### FIELD OF THE INVENTION

The invention relates to two wheel drive motorcycles typically used off-road. More specifically, it relates to the use of an expendable torque overload mechanism that protects internal drive train components from unpredictable shock loads inherent during off-road and sporting uses. The overload mechanism is externally exposed and easily repairable in the field, thus preventing immobilizing drive line failures.

### BACKGROUND OF THE INVENTION

U.S. Pat. No. 4,702,340 illustrates a two wheel drive motorcycle of the type manufactured by the assignee of the present application. The motorcycle has an engine mounted to the frame which provides power and torque through a torque converter to a transmission. The transmission has an output shaft providing power and torque to a rear wheel chain drive and another output shaft providing power and torque through a drive shaft, a one-way clutch, a universal joint and miter gears to a front wheel chain drive. These front drive line components are enclosed within a torque tube and a miter box.

In the past, using normal machine design and strength and material calculations, transmission and drive line components have been manufactured with sufficient torque strength to accommodate engine power, torque output and vehicle weight. However, shock loads are particularly prevalent during off-road and sporting uses. Rotating masses in the transmission and the drive lines can obtain substantial angular momentum. Sudden impact of the front or rear wheel with objects can produce arresting forces many times greater than that predicted for normal weights and traction. At these instants in time, the angular momentum is converted into large forces and torques that can far exceed normal design criteria. This can lead to failures in the transmission or the drive line. Designing drive line components with sufficient strength to handle such large and unpredictable shock forces and torques is difficult and, in any event, would substantially increase weight and cost of the vehicle. Such solutions are also somewhat self-defeating because the added weight only worsens the problem.

The components of the drive line and the transmission are normally enclosed and are difficult to repair in the field. The motorcycle must be substantially disassembled in order to access the transmission or drive line components for repair. These components are enclosed in the crankcase, torque tubes, gear boxes, and are difficult to access. For example, it may be necessary to remove the fuel tank, the seat, fenders, chains, and many other components in order to repair the failed component.

Not surprisingly, a rider can be stranded in the field if a shock load causes a failure in the transmission and drive line.

### SUMMARY OF THE INVENTION

The invention involves the use of an expendable and replaceable torque overload component, preferably one each for the front and rear drive lines, which are externally accessible and easy to replace in the field. In this manner, the shafts, pins, gears, keys, universal joints, and overrunning clutches, all of which are enclosed components, are protected from failure due to shock load torques. It is preferred that these other drive line components also be designed to withstand higher torque loads without adding mass. This is preferably accomplished through the use of keys and keyways and adhesive when appropriate during the assembly of the components of the transmission and the drive lines to enhance the torque capacity of connections between components that are likely to bear significant torque loads. The torque overload component is preferably a shear pin used to mount the drive sprocket for the respective chain drive. It is located so that it is externally exposed and easily accessible to the user. In the rear, the hub of the drive sprocket is mounted to the rear transmission output shaft, and in the front the drive sprocket is mounted to the miter gear output shaft. The shear pin is preferably a roll pin that can be replaced easily with a spare pin using a hammer, or even a rock, in the field.

### BRIEF DESCRIPTION OF THE DRAWINGS

FIG. 1 is a side elevation view of a two wheel drive motorcycle constructed in accordance with the invention, and depicting the overall drive scheme from the engine to both the front and the rear wheels.

FIG. 2 is a cross-sectional view taken along line 2-2 in FIG. 1 showing details of the transmission and the drive sprocket for the chain drive for the rear wheel, including an expendable and replaceable, externally exposed torque overload component assembled in accordance with the preferred embodiment of the invention.

FIG. 3 is a cross-sectional view taken along line 3-3 in FIG. 2 showing details of the gear selector in an engaged position with one of the gears.

FIG. 4 is a cross-sectional view taken along line 4-4 in FIG. 1 showing further details of the drive system, and further illustrating the use of pins, keyways and adhesive to strengthen the torque load capability of the drive system as well as expendable and replaceable, externally exposed torque overload components for both the front and rear wheel drives, all in accordance with the preferred embodiment of the invention.

FIG. 5 is a more detailed cross-sectional view taken along line 5-5 in FIG. 4 illustrating details of the preferred embodiment for the one-way overrunning clutch of the drive system.

FIG. 6 is an exploded perspective view showing the components of the one-way overrunning clutch illustrated in FIG. 5 and FIG. 4.

FIG. 7 is a schematic drawing illustrating the configuration of keyseats in the shaft (FIGS. 7A and 7B) and the hub (FIG. 7D), and a woodruff key inserted in the keyseat within the shaft (FIG. 7C), all in accordance with the preferred embodiment of the invention, in order to strengthen the torque load capacity of the drive system.

FIG. 8 is a schematic drawing illustrating a spring pin.

FIG. 9 is a schematic drawing illustrating a roll pin.

### DETAILED DESCRIPTION OF THE INVENTION

The drawings illustrate a two wheel drive motorcycle constructed in accordance with a preferred embodiment of the invention. This embodiment is illustrative, and various modifications can be made without departing from the spirit and scope of the invention.

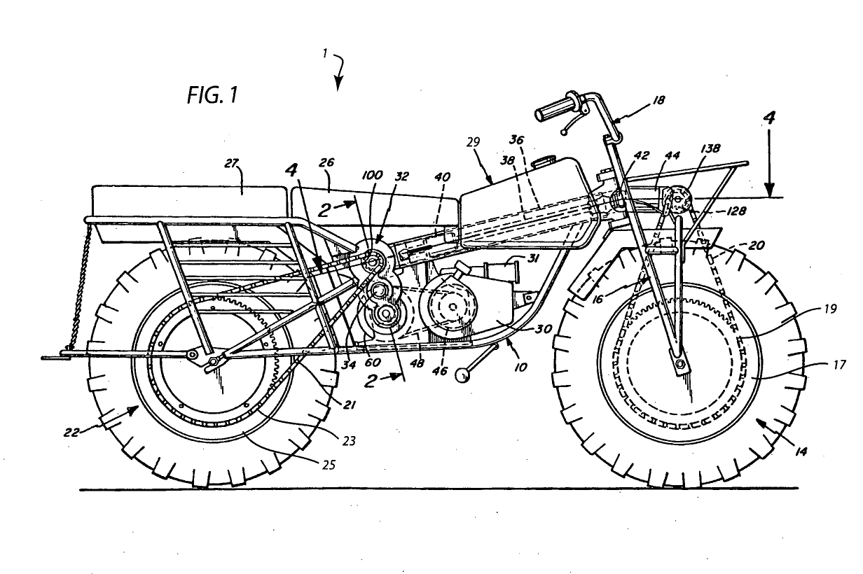

Referring to FIG. 1, the motorcycle 1 of the preferred embodiment of the invention has both front 14 and rear 22 wheels driven by an engine 30 and transmission 32, and it is well suited for multiple uses including off-road use and sporting uses. As mentioned, shock loads are particularly prevalent during off-road and sporting uses. The motorcycle 1 has been designed to 1) increase the torque load capability of the transmission and drive line without substantially increasing the weight of the components, and 2) provide expendable and replaceable, torque overload components which are easily accessible from the exterior of the motorcycle without disassembling. This protects the transmission and drive components from shock load failure and, e.g., reduces the risk of a rider being stranded in the field due to a failure caused by a shock load. It has been found that the torque load capacity of the transmission and drive lines can be enhanced overall, thus reducing the risk of failure, by improving the torque strength of connections between components. As described herein, this is preferably accomplished through the use of keys, keyways, pins and adhesive. As such, this is accomplished with little, if any, weight increase.

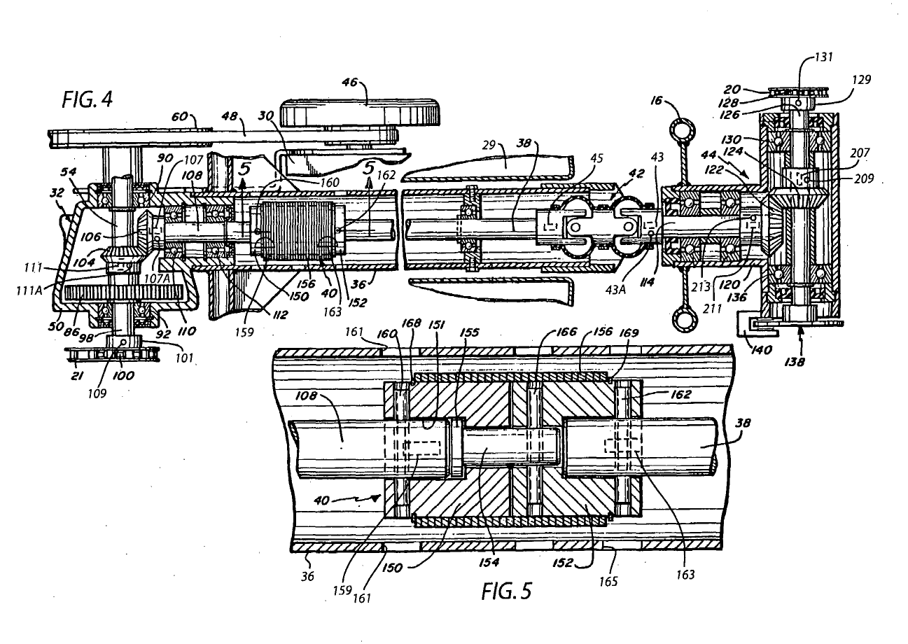

The motorcycle 1 has a frame 10 on which the other components are mounted directly or indirectly. The front wheel 14 is rotatably supported by a front fork 16, which is, of course, also rotatably supported to the front of the frame 10 to allow for turning. A set of handlebars 18 steers the front fork 16 in order to turn the motorcycle 1. The front wheel drive mechanism includes a front wheel drive chain 20. The chain 20 is driven by a drive sprocket 128. The chain driven wheel sprocket 19 is mounted to the hub of the front wheel 14, and provides power to the front wheel 14. As discussed hereinafter, the torque overload mechanism is preferably a shear pin (131 in FIG. 4) used to mount the drive sprocket 128 to the output shaft (126 in FIG. 4) to the miter box (44 in FIG. 4).

Similarly, there is provided a rear wheel drive chain 21 for driving the rear wheel 22 which is rotatably supported on the rear end of the frame 10. A drive sprocket 100 mounted to an output shaft of the transmission 32 drives the rear wheel drive chain 21. The chain 21 is engaged to a chain driven wheel sprocket 23 mounted on the hub 25 of the rear wheel 22, and provides power to the rear wheel 22.

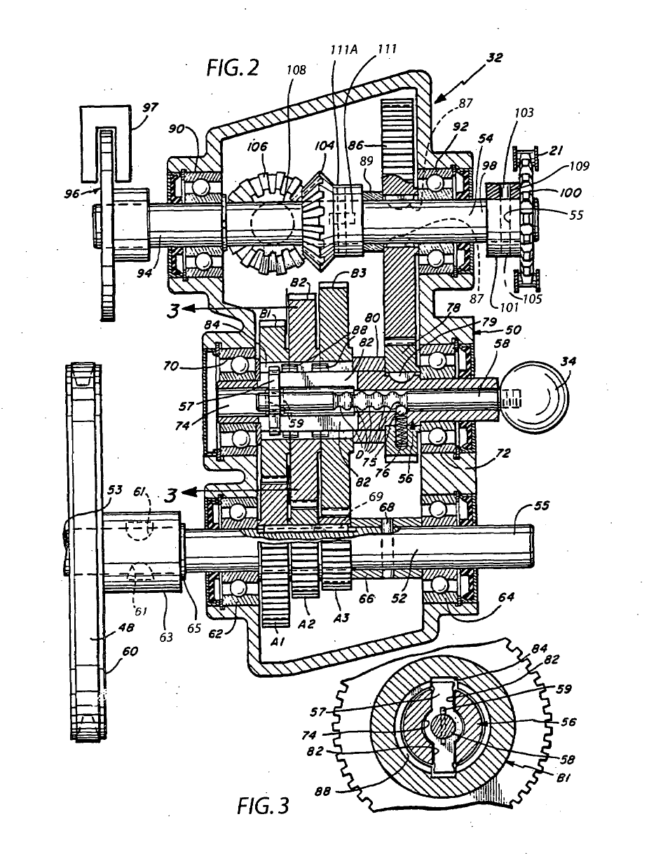

FIG. 1 also illustrates a gas tank 29 and seats 26 and 27 at the top of the frame 10. It is often necessary to remove the gas tank 29 and perhaps the front seat 26 to service the transmission 32 or front drive line located in tube 40. The engine 30 and its carburetor 31 are mounted on the lower end of the frame 10. The transmission 32 is mounted to the frame 10 rearward of the engine 30. A shift knob 34 is used by the operator to set the transmission 32 into one of three different forward gear positions or neutral. The engine 30 provides power to the transmission 32 via a belt 48 and pulley 60, torque converter 46 mounted on the engine 30 and on the transmission 32. The details of the transmission are described hereafter in connection with FIGS. 2 and 3.

Referring now to FIGS. 2 and 3, the preferred transmission 32 includes a housing 50 in which a transmission input shaft 52 is supported, along with a rear transmission output shaft 54, a front transmission output shaft 108 (phantom) and a gear selector shaft 56. The gear selector shaft 56 carries the operating shaft 58 to which the gear selector 57 is mounted. The shift knob 34 is secured to the end of the operating shaft 58 and exposed outside of the housing 50 of the transmission 32 to allow the user to shift gears of the transmission.

The pulley 60 receiving power and torque from the engine belt 48 is mounted to an end of the transmission input shaft 52. More specifically, hub 63 for the pulley 60 is mounted to the end 53 of the transmission input shaft 52 using a pair of woodruff keys 61. Suitable woodruff keys for this location are the #606, 3/16 (thickness)×¾ (radius), made of alloy steel 8630 having 112500 psi tensile, RC40-50. The calculated shear necessary for failure of a properly installed #606 woodruff key is 13,950 lbs. per key. The attachment of the driven pulley 60 preferably includes two such keys. Assuming that the alloy steel has a shear strength of 110,000 lbs. per square inch and that the radius of the input shaft 52 is 0.375 inches, the torque capacity at that location is estimated to be 10462 inch lbs.

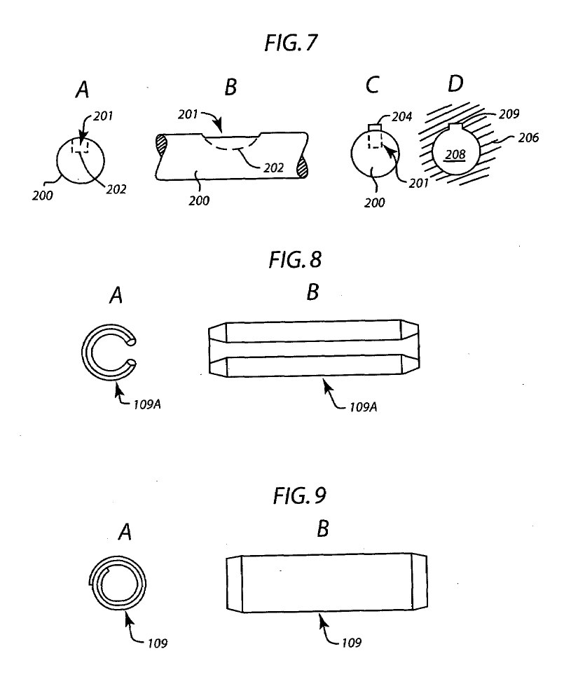

FIG. 7 shows the typical configuration of the keyways or keyseats of a shaft 200 and hub 206, respectively, for the installation of a woodruff key 204. The keyseat 201 in the shaft 209 is shown in FIGS. 7A, 7B and 7C via dotted lines. FIGS. 7A and 7B show the configuration of the keyseat 201 machined into the shaft 200. Note that the base 202 of the keyseat 201 in the shaft is an arc with a constant radius when viewed perpendicularly from the longitudinal axis of the shaft 200. The shape of the keyseat 201 in cross-section (FIG. 7A) is substantially rectangular. FIG. 7C shows a woodruff key 204 installed within the keyseat 201 in the shaft 200. The woodruff key 204 is generally hemispherical (as depicted in FIG. 2) with a constant thickness. FIG. 7D shows a hub 206 with an opening 208 for the shaft 200 and a slot 209 or keyway in the hub 206 adjacent the opening 208 in the shaft 200. In practice, the keyway 209 extends at least to one end of the hub 206 in order to allow the mounting of the hub 206 over the installed woodruff key 204 on the shaft 200. Note that woodruff keys provide resistance to torque, but do not generally provide resistance against axial displacement between components.

Referring again to FIG. 2, the use of two #606 woodruff keys to attach the hub 63 of the pulley 60 to the transmission input shaft 52 is not novel. Preferably, no adhesive is used to mount the hub 63 of the pulley 60 to the shaft 52 in order to facilitate removal of the hub 63 from the shaft 52. A ring 65 mounted around an indention in the shaft 52 prevents the hub 63 from inward movement towards the transmission 32 once the hub 63 and pulley 60 have been mounted. As will be apparent from the following description, the woodruff keys 61 provide ample torque capacity so that there is little risk of failure at this connection, even without the use of adhesive.

The transmission input shaft 52 is supported by bearings 62, 64 at either end of the transmission housing 50. The bearings 62 and 64 are positioned in a conventional manner using snap rings and grease seals so that each of the bearings can remain properly positioned and lubricated. Three gears A1, A2 and A3 are secured to the transmission input shaft 52. Gear A1 is a relatively large gear, gear A2 is an intermediate diameter gear and gear A3 is a small diameter gear. Each of these gears A1, A2 and A3 is keyed to the input shaft 52, and in accordance with the invention is also secured with adhesive. The preferred key 69 is a 3/16 square key having a length of slightly over ½ inch. Assuming that the length of the key is 0.515 inches, its tensile strength is 100,000 lbs. per square inch, and the radius of the input shaft 52 is 0.375 inches, the estimated torque load capacity of the key is 5767 inch lbs. This is substantially less than the torque capacity at the connection between the pulley hub 63 and the input shaft 52. Thus, the torque capacity for the connection between the transmission input shaft 52 and the gears A1, A2 and A3 is preferably enhanced using adhesive for the connection. The preferred adhesive is an anaerobic adhesive provided under the brand name Loctite™, and in particular, either Loctite™ 609 retaining compound (general purpose) or Loctite™ 638 retaining compound (maximum strength). The Loctite™ 609 adhesive has published a steel-on-steel shear strength of 3,000 lbs. per square inch and the Loctite™ 638 adhesive has published a steel-on-steel shear strength of 4,500 lbs. per square inch. The calculations herein assume that the 609 Loctite™ adhesive with a shear strength of 3,000 lbs. per square inch is used. Using the adhesive increases the torque capacity about 1,365 lb. inches (i.e., 2π*length*3,000 lb. inches per square inch). This enhances the torque capacity of the connection between the transmission input shaft 52 and the gears A1, A2 and A3 to about 7,135 inch lbs. The application of the adhesive also has the added benefit of helping to prevent fretting.

A spacer 66 is provided around the input shaft 52 adjacent gear A3. The spacer 66 is secured to the input shaft 52 using a roll pin or spring pin 68. Note that the spacer 66 properly positions the three gears A1, A2 and A3 relative to the support bearings 62 and 64. The spacer 66 does not bear substantial torque loads and therefore spring pin or roll pin 68 is not likely to fail due to shock loads.

The gear operating shaft 56 is similarly provided with end bearings 70, 72 in the transmission housing 50 for its support. As with bearings 62 and 64, the bearings 70 and 72 are provided with retaining rings and grease seals so that the bearings remain properly positioned and lubricated. The gear operating shaft 56 contains a centrally disposed passage 74 for receiving the gear selector shaft 58 which couples the shift knob 34 to the gear selector 57. The gear selector 57, as shown in FIG. 3, is secured to the selector shaft 58 by means of roll pins 59.

The gear selector shaft 58 is provided with a series of five detents D. A registering ball 75 with its associated spring 76 is shown in place registering with one of the detents D, namely the right hand most detent. In this position, the shift knob 34 is disposed all the way into the transmission housing 50. The gear operating shaft 56, which houses the selector shaft 58, supports spur gears B1, B2 and B3. Gears A1, A2 and A3 associated with the transmission input shaft 52 are engaged with gears B1, B2 and B3, respectively. Thus, when the transmission input shaft 52 is rotating to cause the gears A1, A2 and A3 to rotate, gears B1, B2 and B3 are likewise in rotation.

Also mounted to the gear selector shaft 56 is a small gear 78 (preferably 32 teeth). A woodruff key 79, preferably a #404 woodruff key, is used to mount the small gear 78 to gear selector shaft 56 along with a spacer 80 between the small gear 78 and the gear B3. The #404 woodruff key suitable for this location (⅛ (thickness)×½ (radius), made of alloy steel 8630 having a 112,500 psi tensile, RC 40-50) has a calculated shear necessary for failure of about 6,200 lbs. per key. Assuming that the radius of the shaft 58 is 0.375 inches, the estimated torque capacity for the key is 2,325 inch lbs. Again, it is desirable to increase the torque capacity at this connection using adhesive, as described previously regarding the gears A1, A2 and A3. The estimated increase in torque capacity for this connection is about 1,986 lb. inches due to the use of adhesive (i.e., 2 π×R×length×3,000 lb. inches per square inch). Thus, the total torque capacity at this connection is estimated in the preferred embodiment to be about 4,310 inch lbs.

The gear operating shaft 56 is provided with diametrically disposed slots 82, see FIG. 3, that extend the width of the three gears B1, B2 and B3. These diametrically disposed slots 82 permit movement of the gear selector 57 along the length of the gear selector shaft 56 under the control of the detent arrangement that is illustrated in FIG. 2. The gears B1, B2 and B3 each have a corresponding slot 84. In FIG. 2, the gear selector shaft 57 is shown to be in engagement with the slot 84 in the gear B1. Referring to FIG. 3 in this regard, note that the gear selector 57 extends into the slot 84 to provide driving power from only gear B1 (to which it is engaged) to the operating shaft 56. Although the gears B2 and B3 are rotating, the gear selector 57 provides power only from gear B1 to operating shaft 56 because that is the gear to which it is engaged. Thus, when the gear selector 57 is engaged with gear B1, operating shaft 56 is driven via power from gears A1 and B1, and in turn drives small gear 78, which is keyed to the operating shaft 56.

The shift knob 34 may also be moved to the right in FIG. 2. The next detent position is a position intermediate gears B1 and B2. In this intermediate position 88 (as well as a similar intermediate position 88 between gears B2 and B3) a circumferential slot 88 causes disengagement between the gear selector 57 and either of the gears B1 and B2. (The other slot 88 associated with gears B2 and B3 similarly provides for disengagement.) When the gear selector 57 is located in the slots 88, the gears B1, B2 and B3 rotate freely with respect to the gear selector 57. When the shift knob is moved even further to the right, the gear selector 57 selectively engages gear B2, or when it is all the way to the right, gear B3.

The rear transmission output shaft 54 is supported at the top of the transmission housing 50. For this purpose, there is a bearing 90 on one side of the housing 50 and a bearing 92 on the other side of the housing 50. The bearings 90 and 92 for the transmission output shaft are preferably retained in place using a retaining ring and also preferably have a grease seal to prevent leaking of the grease from the housing 50. The left end 94 of the rear transmission output shaft 54 is provided with a disk brake 96. FIG. 2 schematically illustrates a caliper 97 for operating the disk brake 96 for the rear wheel. The transmission output gear 86 receives power and torque from the small gear 78 mounted to the operating shaft 58. The transmission output gear 86 is keyed to the transmission output shaft preferably using two #404 woodruff keys as well as adhesive to enhance the torque load capabilities of the connection. Note that the torque ratio between gears 86 and 78 is preferably 2:1, thus the torque load capability upstream of this interface need not be as great in order to avoid failure due to shock loads. As a general matter, maximum torque loads increase as power and torque is transmitted from the engine towards the wheels. Referring in particular to the connection of gear 86 to transmission output shaft 54, the calculated torque capacity provided for the two #404 woodruff keys is about 4,650 lbs. inches and the preferred adhesive will provide an estimated additional 1,484 lb. inches in torque capacity, for a total estimated torque capacity of the connection of 6,134 inch lbs. The use of woodruff keys 87 at this location is not novel, but the use of adhesive to enhance the torque capacity at this location is believed to be novel.

At the right hand end 98 of the rear transmission output shaft 54, there is secured a sprocket 100 which is adapted to carry the rear drive chain 21. The sprocket 100 has a integral hub 101 that is mounted over the end 98 of the rear transmission output shaft 54. The hub 101 includes diametrically opposed holes 103, 105 which are aligned with a diametric hole 53 through the end 98 of the shaft 54. A shear pin 57 is mounted through the holes 103, 105 in the hub 101 and the diametric hole 55 in the shaft 54. Referring to FIGS. 8 and 9, the shear pin 109 is preferably a roll pin as shown in FIG. 9, but can alternatively be a spring pin 109A as shown in FIG. 8. Both the roll pin 109 and the spring pin 109A will exert outward spring force against the holes 103, 105, 55 to retain the pin 109, 109A in place. Preferably, a ¼ inch diameter roll pin 109 or spring pin 109a is used. The preferred pins are steel and have a minimum double shear strength of 7,360 lbs. for the roll pin 109 and 7,700 lbs. for the spring pin 109A in accordance with ANSI Standard D18.8.2. Referring again to FIG. 2, assuming that the radius of shaft 54 is 0.375 inches, the estimated torque capacity for the ¼ inch shear pin is about 2,760 inch lbs. using roll pin 109, and about 2,887 inch lbs. using the spring pin 109A. Note that in accordance with the invention, the torque capacity of this connection is substantially less than the torque capacity for connections upstream towards the engine, especially when one considers that the torque ratio between gears 86 and 78 is preferably about 2:1. Thus, upon incurring a shock torque load by the rear wheel, it is substantially more likely that the roll pin 109 will shear than upstream connections, causing the failure to occur at that point and protecting components and connections between components upstream towards the engine. It is important, however, that the strength of the shear pin be sufficient to withstand normal loads without failure. Note also that the roll pin 109, 109A is accessible externally, and does not require any disassembly to remove or replace. Even if failure does occur, it is well-suited for infield servicing.

FIGS. 2 and 4 also illustrate miter gears 104 and 106 for providing drive power and torque from the rear transmission output shaft 54 to the front transmission output shaft 108. Each miter gear 104, 106 is affixed to the respective shaft 54, 108, using a woodruff key 111, 107 (preferably a #606 woodruff key), and a roll pin 111A, 107A (preferably a 3/16 inch roll pin) without adhesive thus providing an estimated 6,880 inch lbs. of torque capacity (5,230 inch lbs. for the #606 woodruff key and 1,650 inch lbs. for the 3/16 inch roll pin). Note that the roll pins 111A, 107A are necessary in order to prevent axial movement of the miter gear along the shaft. It is desired to mount the miter gears 104 and 106 without adhesive in order to facilitate disassembly. Furthermore, while the arrangement of the woodruff key 111 and roll pin 111A is shown clearly in FIG. 2 for the miter gear 104 and output shaft 54, the arrangement for woodruff key 107 and roll pin 107A for miter gear 106 and front output shaft 103 is not, but the configuration is preferably similar to that shown with respect to miter gear 104 and shaft 54.

Referring now in particular to FIG. 4, the front miter box 44 includes a housing 120 having supported therein a first miter gear 122 and a second miter gear 124. The front miter gears 122, 124 are preferably attached to the respective shafts 114, 126 using #606 woodruff keys 211, 207, and a 3/16 inch roll pin 213, 207 in the same manner as miter gear 104 was connected to rear transmission output shaft 54 and miter gear 106 was connected to front transmission output shaft 108. Without using adhesive, this provides for torque capacity of 6,880 inch lbs. at each connection. This should be sufficient to protect the connection from failure. If desired, however, this connection can be made stronger by using adhesive, e.g. using adhesives described above would increase the torque capacity at these connections an estimated amount of 2,650 inch lbs. In accordance with the invention, it may be desirable to use adhesives similarly to connect the miter gears 104 and 106 to the respective shafts 54, 108. Using adhesive in this manner at these locations, while probably not necessary, will even further reduce the risk of failure occurring at these locations, and this is particularly desirable because these locations are difficult to access.

The front wheel drive shaft 126 is connected to miter gear 124 as mentioned and is supported by ball bearings 130 and 144. The ball bearings include a seal and retaining ring as previously described. One end of the shaft 126 (extending downward in FIG. 4) is provided with disk brake 138 for the front wheel. Caliper 140 associated with the front disk brake 138 is shown in FIG. 4. The other end of the front drive shaft 126 is connected to the sprocket 128 for the front wheel chain drive 20. The sprocket 128 has a hub 129 similar to that shown for the rear wheel. A shear pin 130 is mounted through the hub 129 and the end of the drive shaft 126 as described in connection with the rear transmission output shaft 54, hub 101 and shear pin 109. Preferably, the dimensions of the shaft 126, the hub 129 as well as the shear pin 131 are the same as similar components for the rear wheel drive. Note that roll pin 131 is accessible externally, thereby providing convenient access in case pin 131 fails and needs to be replaced in the field. Note that the torque load capacity for the preferred roll pin 131, a ¼ inch roll pin, is about 2,760 inch lbs. given a shaft radius of 0.375 inches, and 2,887 inch lbs. if the alternative spring pin is used.

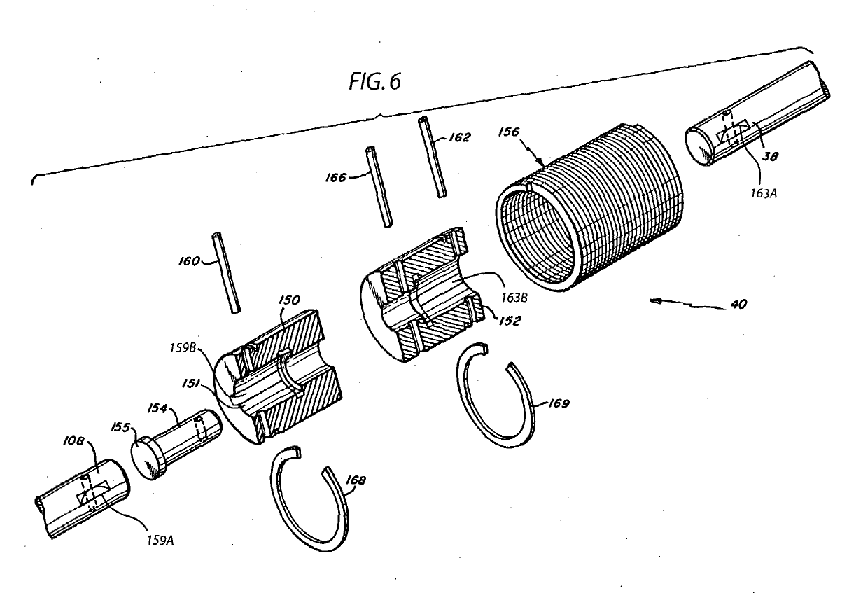

The components of the overrunning clutch mechanism are now described in connection with FIGS. 4, 5, and 6. Generally speaking, the overrunning clutch mechanism is depicted by reference numeral 40. The clutch 40 comprises a first clutch boss 150, and a second clutch boss 152. In accordance with U.S. Pat. No. 4,702,340 which is incorporated herein by reference, a shouldered pin 154 is used to prevent the clutch bosses 150 and 152 from exaggerated separation when the spring 156 loosens to release the clutch 40. The clutch 40 releases when it is necessary for the front wheel 14 to rotate faster than the rear wheel 22, as is typical during a turn. A roll pin 166, see FIG. 5, is used to secure the shouldered pin 154 in place to loosely connect the clutch bosses 150, 152. Note that the head 155 of the shouldered pin 154 sits within the recess 151 of clutch boss 150 and is allowed to rotate when the clutch is released and shaft 38 is allowed to rotate relative to shaft 108. Thus, there is no substantial load on roll pin 166.

Clutch boss 150 is connected to transmission output shaft 108 via a woodruff key 159, preferably a #606 woodruff key and a 3/16 inch roll pin 160. The strength of this connection is thus approximated to be 6,880 inch lbs. of torque capacity, as previously described. Note that tube 36 includes access holes 161 to facilitate the installation of roll pin 160 within the tube 36. The woodruff key 159 is inserted within the keyseat 159a on the shaft 108 and engages the keyway 159b in the clutch boss 150. The pin 160 provides torque resistance but also fixes the axial position of the boss 150 on the shaft 108.

The shaft 38 is mounted to clutch boss 152 in similar fashion, namely using a woodruff key 163, preferably a #606 woodruff key, and a roll pin 162 that is mounted through holes 165 in the tube 36. The woodruff key 163 (shown in FIGS. 4 and 5) is installed in keyseat 163A on shaft 38 and keyway 163B in clutch boss 152. The spring 156 is assembled over the clutch bosses 150 and 152 and held in place using retaining rings 168 and 169. Under normal operating conditions, the spring 156 tightens as the shaft 108 drives the clutch boss 150 and through the tightened spring 156 also drives clutch boss 152 to provide power to shaft 38, shaft 38 transmits power through universal joint 42 (FIG. 4) to the front miter box 44 and the front wheel 14, respectively. However, if the front wheel needs to rotate at a faster speed, such as necessary when turning the motorcycle, the spring 156 loosens and allows clutch boss 152 to slip with respect to clutch boss 150.

The connection of the U joint 42 and the drive shaft 38 is preferably strengthened using a #606 woodruff key 45, thus providing torque capacity of about 5,230 inch lbs. at that connection without the use of adhesive. The U joint 42 is connected to the front miter box input shaft 114 preferably using both a #606 woodruff key 43 and a 3/16 inch roll pin 43A, thus providing an estimated torque capacity of 6,880 inch lbs. for that connection.

Note that within the front miter box 44, the miter gear 122 is preferably connected to the miter box input shaft 114 using a #606 woodruff key and a 3/16 inch roll pin, reference numbers 211 and 213, respectively, thus providing an estimated torque capacity of 6,880 inch lbs. for the connection. Likewise, miter gear 124 is preferably connected to the output shaft 126 using a #606 woodruff key and a 3/16 inch roll pin, reference numbers 207 and 209, respectively, again providing an estimated torque capacity of 6,880 inch lbs. for the connection.

As should be apparent to those skilled in the art, the torque capacity at the front wheel hub 129, and at the rear wheel hub 101, are significantly less than the torque capacity of the other connections along the drive train and within the transmission. In accordance with the invention, connections between components which are susceptible to failure upon bearing increased torque loads are strengthened through the use of keys or adhesive, or other means known to those skilled in the art, without substantially increasing the weight of the system. Such design forces failures due to shock loads, when failures occur, to occur most probably at either the front hub 129 or the rear hub 101, where the respective roll pin is more likely to shear than internal components and connections between the internal components are likely to fail. Since the roll pins 131, 109 are accessible without disassembling, they are relatively easy to replace. For example, a user can carry extra roll pins on the motorcycle 1 and replace them as necessary to avoid being stranded in the field. On the other hand, those skilled in the art will recognize that, within the scope of the invention, the torque overload component make have a different configuration and location.

The following table summarizes the estimated torque capacity, torque ratio and safety factor for each of the connections discussed in accordance with the preferred embodiment of the invention.

TABLE 1

| | | Torque | Safety |
|---|---|---|---|
| Connection | Torque Capacity | Ratio | Factor |
| 1. Torque overload components | 2,887 inch lbs. | 1 | |
| at wheel drive sprockets (129, | | | |
| 131 and 109, 101) | | | |
| 2. Front miter gears (122, 124) | 6,880 inch lbs. | 1 | 2.4 |
| without adhesive | | | |
| 3. U joint (42) to front miter | 6,880 inch lbs. | 1 | 2.4 |
| box input shaft (114) | | | |
| 4. U joint (42) to front drive | 5,230 inch lbs. | 1 | 1.8 |
| shaft (38) | | | |
| 5. Drive shaft (38) to clutch | 6,880 inch lbs. | 1 | 2.4 |
| boss (152) | | | |
| 6. Clutch boss (150) to front | 6,880 inch lbs. | 1 | 2.4 |
| transmission output shaft (108) | | | |
| 7. Front transmission output | 6,880 inch lbs. | 1 | 2.4 |
| shaft (108) to miter gear (106) | | | |
| 8. Miter gear (104) to rear | 6,880 inch lbs. | 1 | 2.4 |
| transmission output shaft (54) | | | |
| 9. Transmission output shaft | 6,134 inch lbs. | 1 | 2.1 |
| (54) to final transmission gear | | | |
| (86) | | | |
| 10. Small transmission gear (78) | 4,310 inch lbs. | ½ | 3 |
| to transmission operating shaft | | | |
| (58) | | | |
| 11. Transmission input shaft | 7,135 inch lbs. | ½ | 5 |
| (52) to gear A1 | | | |
| 12. Driven pulley (60) to | 10,462 inch lbs. | ½ | 7.3 |
| transmission input shaft (52) | | | |

All of the connections 2 through 9 have a safety factor of greater than 1.5 in accordance with the preferred embodiment of the invention. Note that the connections identified in rows 2, 3, 5, 7, 8 and 9 have, in accordance with the invention, been strengthened in order to force the failures due to shock loads to occur at the hubs for the wheel drive sprockets 100, 128. It should be apparent to those skilled in the art that other ways of strengthening these connections are possible within the scope and spirit of the invention.

I claim:

1. A dual wheel drive motorcycle comprising:
a frame;
a front wheel;
a rear wheel;
a vehicle engine supported on the frame;
a transmission that receives power and torque produced by the engine and, through multiple engagable gears, provides power and torque to a rear wheel drive line and a front wheel drive line;
a rear wheel drive mechanism including an expendable and replaceable, externally exposed torque overload component; and
a front wheel drive mechanism including expendable and replaceable, externally exposed torque overload component;
wherein the transmission and the front and rear drive lines are designed to withstand greater torque loads than the torque overload component for either the front wheel drive mechanism or the rear wheel drive mechanism.

2. A dual wheel drive motorcycle as recited in claim 1 wherein the front wheel drive mechanism is a chain drive mechanism having a front drive sprocket connected to an output shaft in a front miter box and the torque overload component comprises a shear pin used to mount a hub of the sprocket to the output shaft.

3. A dual wheel drive motorcycle as recited in claim 1 wherein the rear wheel drive mechanism is a chain drive mechanism having a rear drive sprocket connected to a transmission output shaft and the torque overload component comprises a shear pin used to mount a hub of the sprocket to the transmission output shaft.

4. A dual wheel drive motorcycle as recited in claim 3 wherein a rear transmission output shaft is driven by the transmission, the rear transmission output shaft having a diametric hole through its end, and the hub of the sprocket has two holes corresponding to the diametric hole through the end of the rear transmission output shaft, and further wherein the sprocket is mounted to the end of the rear transmission output shaft by aligning the two holes in the hub with the diametric hole through the end of the drive shaft and installing the shear pin therethrough.

5. A dual wheel drive motorcycle as recited in claim 2 wherein:
a front transmission output shaft is driven by the transmission;
an overrunning clutch mechanism connects the front transmission output shaft to a front drive shaft;
the front drive shaft drives a miter gear input shaft connected to the front drive shaft via a universal joint;
a miter gear arrangement having a front miter gear connected to an end of the miter gear input shaft and drives another miter gear connected to a miter gear output shaft;
the miter gear output shaft has a diametric throughhole via one end, the hub of the sprocket has two holes corresponding to the diametric hole through the miter gear output shaft; and
the sprocket is mounted to the miter gear output shaft by aligning the holes in the sprocket hub with the hole through the miter gear output shaft and installing the shear pin therethrough.

6. A dual wheel drive motorcycle as recited in claim 5 wherein the overrunning clutch comprises:
a first clutch boss connected to the front transmission output shaft, the torque load capability of the connection being enhanced by installing a key in a keyseat in the front transmission output shaft and in a keyway in the first clutch boss respectively to resist relative angular motion between the components; and
a second clutch boss connected to the front drive shaft, the torque load capability of the connection being enhanced by installing a key and a keyseat in the front drive shaft and in a keyway in the second clutch boss respectively to resist relative angular motion between the components.

7. A dual wheel motorcycle as recited in claim 1 wherein the torque load capability of the transmission and drive lines are enhanced through the use of keys and keyways and adhesive during the assembly of the components.

8. A dual wheel motorcycle as recited in claim 1 wherein the torque load capability of connections between torque load bearing components in the transmission and drive lines are enhanced during the assembly of the components such that the safety factor of the torque capacity for the internal connections of the transmission the drive line is at least 1.5 times greater than the externally exposed torque overload components.

9. A dual wheel motorcycle as recited in claim 8 wherein the torque load capability of the transmission is enhanced through the use of adhesive to secure the transmission output shaft to the final gear in the transmission.

10. A motorcycle comprising:
a frame;
a front wheel;
a rear wheel;
a vehicle engine supported on the frame;
a transmission that receives power and torque produced by the engine and, through multiple engagable gears, provides power and torque to a rear wheel drive line; and
a rear wheel drive mechanism including an expendable and replaceable, externally exposed torque overload component;
wherein the rear wheel drive line in the transmission are designed to withstand greater torque loads than the torque overload component for the rear wheel drive mechanism.

11. A motorcycle as recited in claim 10 wherein the transmission further provides power and torque to a front wheel drive line; and the motorcycle further comprises a front wheel drive mechanism that receives power and torque from the front wheel drive line, the front wheel drive mechanism including an expendable and replaceable externally exposed torque overload component, wherein the transmission and the front drive line is designed to withstand greater torque loads than the torque overload component for the front wheel drive mechanism.
